(19) United States
(12) Patent Application Publication
(10) Pub. No.: US 2009/0168755 A1
(43) Pub. Date: Jul. 2, 2009

(54) Enforcement of privacy in a VoIP system

(76) Inventors: Dennis Peng, Palo Alto, CA (US); Jeff Peck, Palo Alto, CA (US); Toby Farrand, Palo Alto, CA (US)

Correspondence Address: CARR & FERRELL LLP, 2200 GENG ROAD, PALO ALTO, CA, 94303, US

(21) Appl. No.: 12/006,587

(22) Filed: Jan. 2, 2008

(51) Int. Cl. H04L 12/66

(52) U.S. Cl. 370/352

(57) ABSTRACT

Systems and methods for providing privacy in a VoIP system are provided. In exemplary embodiments, an incoming call is received. A caller ID associated with the incoming call is determined. A category based on the caller ID is associated with the incoming call. Based on the category, a call treatment database is accessed to determine at least one call treatment associated with the category. The at least one call treatment is then applied to the incoming call.

### BACKGROUND OF THE INVENTION

1. Field of the Invention

This invention relates generally to voice over Internet Protocol (VoIP) technology, and more particularly to implementation of telephone privacy in a residential or home-office environment.

2. Description of the Background Art

In a public switched telephone network (PSTN), an initiating phone connects to a circuit switch and the PSTN via a first POTS line. A destination phone connects to the circuit switch and the PSTN via a second POTS line. The circuit switch electrically connects the initiating phone to the destination phone over the PSTN. The electrical connection is maintained for an entire duration of a phone call between the initiating phone and the destination phone. The electrical connection in the PSTN is commonly referred to as “circuit switched.” A problem with the PSTN is that because much of a conversation is silence, maintaining the electrical connection for the duration of the phone call wastes available bandwidth in the circuit switch.

Voice over Internet Protocol (VoIP) is a technology that permits phone calls to be carried over the Internet as opposed to over the PSTN. In VoIP, a device known as an analog telephone adapter (ATA) or media gateway serves as an interface between an analog phone and the packet-based Internet. The ATA may be a standalone device or may be incorporated into another device such as a cordless phone base station or broadband modem. An initiating ATA converts analog signals from an initiating phone into packets using a voice codec (coder/decoder) algorithm. At the destination phone, to receive an incoming VoIP phone call, a destination ATA receives packets into a buffer and uses the same codec algorithm to convert the packets back into analog signals.

Conventionally, ATAs provide VoIP functionality via a connection to a broadband modem, such as through a cable modem or a digital subscriber line (DSL) connection to the Internet. Typically, ATAs provide a foreign exchange subscriber (FXS) port to connect to an analog phone.

Oftentimes, a VoIP service provider strives to emulate the behavior and reliability of the PSTN while offering a lower cost for delivering the service and/or increased functionality. Most VoIP services, however, provide lower reliability than familiar PSTN telephone service because of the inherently lower reliability of having to rely upon a broadband connection rather than a circuit switched connection. Further, though VoIP services are typically less expensive than PSTN-delivered services, they often suffer from inferior voice quality. A challenge and opportunity for VoIP services is to not only correct these disadvantages, but also offer capabilities and user experiences that traditional PSTN services cannot efficiently offer.

One area of frequent annoyance to telephone users is interruption, intrusion, and diminished privacy that comes from unwanted telephone calls from people or entities with whom the telephone user does not want to speak. Telephone users go to extraordinary lengths and suffer significant inconvenience to avoid such calls. Many people do not list their telephone number so as to discourage solicitations and other unwanted calls. They do this even though it inconveniences friends and neighbors who might have a legitimate need to place a call that would normally be welcomed by the telephone user. These legitimate callers may not know the user's telephone number and would benefit from being able to find the number through a public listing. The National Do Not Call list attempts to reduce unwanted solicitations, but users are still subjected to unwanted calls from pollsters and non-profit organizations who are not subject to the National Do Not Call list restrictions. Features like anonymous call reject have been provided in which all calls lacking caller ID are rejected, but these features are typically inflexible in how they treat anonymous calls. Further, many undesirable calls come from callers who do not block their caller ID. Devices have been sold that play special information tones (SIT) to spoof telemarketing computers into concluding that a particular phone number is out of service, but they rely on heuristics to spoof automatic dialing systems, which do not always work.

These methods to preserving privacy have tended to be scattered and uncoordinated. The methods have not taken advantage of network connectivity to coordinate an integrated approach to stopping unwanted phone calls. Furthermore, these methods have not provided easy mechanisms for the user to influence how privacy rules are enforced nor have they provided much subtlety in how privacy can be balanced with the convenience desired by a legitimate caller. Therefore, a need exists in industry to address the aforementioned deficiencies and inadequacies.

### SUMMARY OF THE INVENTION

Embodiments of the present invention overcome or substantially alleviate prior problems associated with privacy in a VoIP system. In exemplary embodiments, an incoming call is received by a call vetting server. In some embodiments, the incoming call is redirected to the call vetting server from a ATA associated with a user receiving the incoming call. In other embodiments, the incoming call is directly received by the call vetting server.

A call identifier of the incoming call is also determined. Based on the caller ID, the incoming call is categorized. The categories may be customized by the user or be default categories. Subsequently, a call treatment database is accessed to determine at least one call treatment associated with the category. The at least one call treatment is then applied to the incoming call.

### BRIEF DESCRIPTION OF THE DRAWINGS

FIG. 1a and FIG. 1b are exemplary block diagrams illustrating an environment in which embodiments of the present invention may be practiced.

FIG. 2 is an exemplary block diagram of a VoIP provider system.

FIG. 3 is an exemplary block diagram of a call vetting server.

FIG. 4 is an exemplary interface of a call log.

FIG. 5 is a flowchart of an exemplary method for enforcement of privacy in of VoIP system.

### DETAILED DESCRIPTION OF EXEMPLARY EMBODIMENTS

Embodiments of the present invention are directed to systems and methods for screening unwanted telephone calls and maximizing likelihood that an incoming telephone call is from a person with which a user wants to talk. Exemplary embodiments also may provide flexible ways to control how calls are handled so that legitimate callers are not inconvenienced by call privacy mechanisms.

In exemplary embodiments, a system for screening and managing call flows to preserve a user's privacy is comprised of an analog telephone adapter (ATA) and a broadband connection coupled to a service provider system. The ATA or the service provider system may be configured to detect a caller identifier (caller ID) or lack thereof for an incoming call and to respond to the call according to rules set by the user through a graphical user interface (e.g., a web interface). The rules may be stored locally at the ATA or in a centralized network storage location. Based on the rules, the call may be terminated, cause an announcement made to the calling party (e.g., to indicate that the call is being rejected), or trigger one or more events intended to disambiguate a source of the call and verify that the user (i.e., called party) wants to receive the call before signaling the user that there is an incoming call. In some embodiments, the ATA may redirect the call through the broadband connection to the service provider to perform the functions of embodiments of the present invention.

For simplicity, the following discussion will provide embodiments whereby the service provider system performs the features of the present invention. It should be noted that the ATA may perform some or all of the functions described for the service provider system.

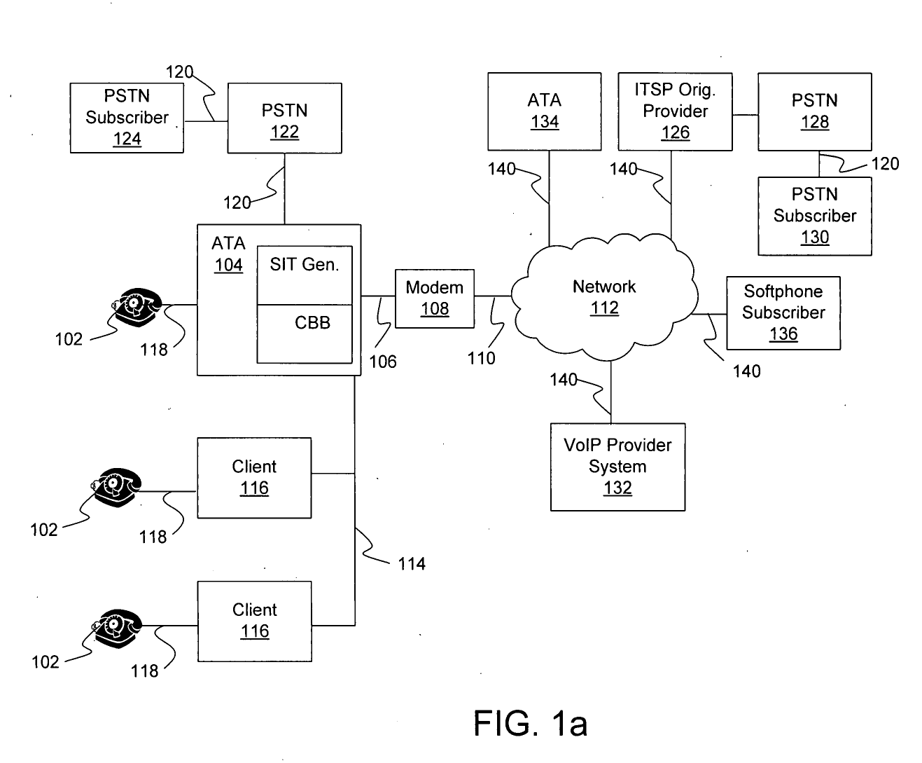

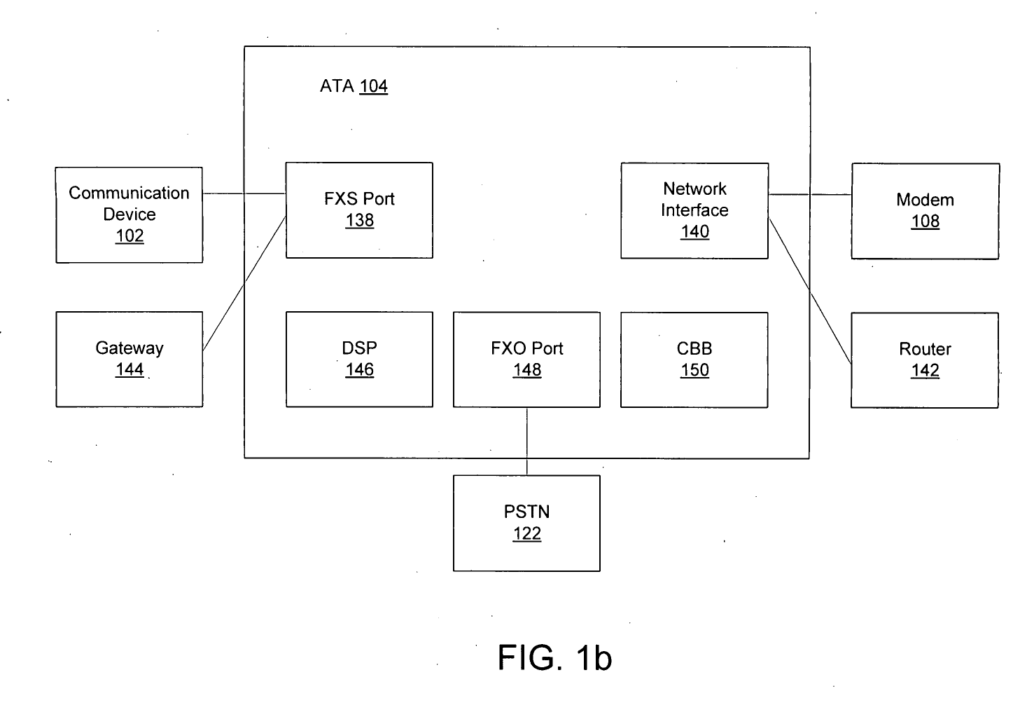

FIG. 1a illustrates an exemplary environment 100 in which embodiments of the present invention may be practiced. In exemplary embodiments, a VoIP user utilizing a communication device 102 may couple a home media gateway such as a hub or an analog telephone adapter (ATA) 104 to a network connection 106 via a modem 108 through a broadband network connection 110 to a network 112. For simplicity of discussion, embodiments of the present invention will be discussed with reference to the ATA 104. However, it should be understood that the ATA 104 may be a hub or any other home media gateway device.

In another embodiment, the ATA 104 may provide a local area network connection 114 to couple one or more client devices 116. The ATA 104 and client devices 116 can each provide FXS channels 118 for locally connected communication devices 102. The communication devices 102 may comprise telephones, answering machines, cordless phones, fax machines, modems, or other communication equipment.

In another embodiment, the client device 116 and communication device 102 may be combined into a network handset device communicating to the ATA 104 over a wireless communication medium. In one example, the wireless communication medium comprises the Digital Enhanced Cordless Telecommunications (DECT) standard. Those skilled in the art will appreciate that the network handset device may communicate over any wireless communication medium.

The ATA 104 can optionally be coupled to a landline interface through a foreign exchange office (FXO) port 120 to carry calls through the PSTN 122 to a PSTN subscriber 124. Alternatively, calls may be routed to the PSTN subscribers 124 through the network 112 using session initiation protocol (SIP) ultimately through an Internet telephony service provider (ITSP) 126 which couples the call through a PSTN connection 128 to a destination PSTN subscriber 130. Alternatively, another subscriber to the VoIP service (or another service which peers with the VoIP service) can route a call from an originating ATA to the destination ATA via a VoIP provider network system 132.

In various embodiments, inbound calls directed to the VoIP customer with the ATA 104 can originate from four possible sources. First, if the ATA 104 is connected to the landline 120, then inbound calls can arrive from an originating PSTN subscriber 124 to the destination ATA 104 via the PSTN 122 and landline 120. The destination ATA 104 may apply call treatments (as will be discussed further below) locally or may use SIP to pass the call through the network 112 to a caller vetting server located at the VoIP provider system 132.

In a second embodiment, if the ATA 104 is not connected to a landline 120 or the landline 120 is busy which results in the call being redirected through a call forward busy feature to a phone number provided by an ITSP (e.g., ITSP origination provider 126) or the call is directed to a phone number assigned by a VoIP service and not associated with the landline 120, then the call originating from the PSTN subscriber 130 may be routed to the ITSP origination provider 126 for the customer's assigned phone number. The ITSP origination provider 125 may use SIP to route the call through the network 112 to the VoIP provider system 132 where it is routed to the caller vetting server.

In a third embodiment, if the caller is another subscriber to the same VoIP service as the destination (or another VoIP provider who peers with the VoIP service), then the call may originate from an ATA 134 and is routed through the network 112 using SIP to the VoIP provider system 132 where it is routed to the caller vetting server.

In a fourth embodiment, if the call is placed from a softphone 136 (e.g., Skype or GoogleTalk) with whom the VoIP provider has peered connections, then the call is routed through the network 112 to the VoIP provider system 132. The call may then be routed via SIP to the caller vetting server.

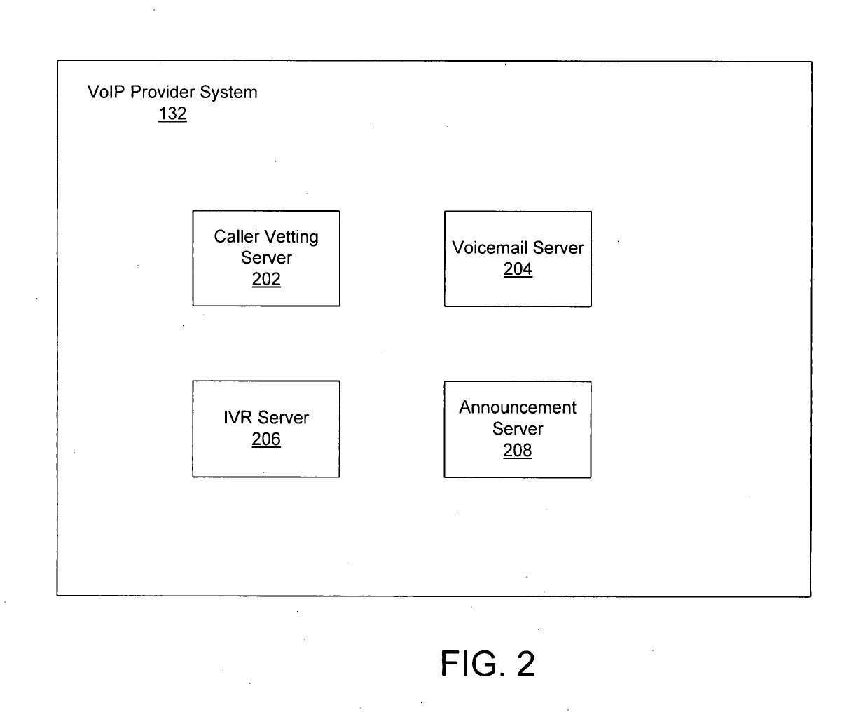

Once the call from whatever source reaches the caller vetting server, then various call treatments may be applied based on, for example, the caller ID (or lack thereof), address of the calling party, or other factors such as time of day, time of year, proximity to an election, calling patterns or telemetry gathered from the destination ATA including missing telemetry which may arise from a loss of power or broadband connectivity to the ATA), or other factors. The caller vetting server and VoIP service system 132 will be discussed in more details in connection with FIG. 2.

Referring now to FIG. 1b, a detailed block diagram of the ATA 104 in operation is shown. As previously discussed, the home media gateway or the ATA 104, couples to a source of wide area network (WAN) information such as the modem 108 via a network interface 140, a user's router 142 for general purpose data networking, a local communication device 102 through an FXS port 138, and optionally the user's PSTN phone line. In another embodiment the FXS port 138 may allow a user's communication device(s) 102 to be directly connected to a gateway 144. In this embodiment, the ATA 104 may also serve as a client device.

In some embodiments, the ATA 104 may control a network in a home environment over a user's existing home line connection. A standard such as the Home Phone Network Alliance (HPNA) can be used to implement a high-speed network over the user's phone line that does not interfere with the voice or DSL network traffic which may also exist on the phone wiring.

The ATA 104 may perform several functions. First the ATA 104 may route network traffic between the WAN and a user's local area network (LAN) as well as HPNA. The ATA 104 may also enforce quality of service (QoS) to assure that real-time traffic such as telephony is prioritized higher than best effort traffic typically carried over the user's LAN. This QoS may maximize quality of VoIP phone calls carried in the home or business environment.

The ATA 104 may also comprise a digital signal processor 146. The digital signal processor 146 may be configured to perform audio compression and decompression, echo cancellation, and audio mixing. Any of these functions may be required in order to provide VoIP service.

In some embodiments, the ATA 104 comprises an FXO port 148. The FXO port 148 may be configured to allow the ATA 104 to route calls directly to the PSTN 122 in addition to routing calls via VoIP via a WAN connection.

The ATA 104 may further comprise input devices such as lights, buttons, a speaker, a microphone, and/or other input devices that allow a user to provide caller treatment inputs. In exemplary embodiment, a caller blocking button (CBB) 150 may be provided. For example, the CBB 150 can be pressed on the ATA 104 or a client 116 to indicate that a particular caller should be added to the caller's black list. In one embodiment, the CBB 150 may be multiplexed with other functions such as deleting voicemails. In alternative embodiments, separate controls or buttons may be provided for these other functions.

The ATA 104 may communicate with one or more client devices 116 (e.g., scouts) through the HPNA network established on the user's twisted pair telephone wiring. Any network technology adequate to carry streamed media such as voice can be used for this communication between the ATA 104 and the client devices 116. For example, interconnecting the ATA 104 and the client device 116 using IP networking over AC wiring (e.g., HomePlug) or over a wireless network (e.g., 802.11b, 802.11g, or DECT) is possible.

In addition to HPNA network connection, the client device 116 may perform other functions. In one embodiment, the client device 116 may be coupled to the FXS port 138 to allow the user's phone to couple to the ATA 104. The client device 116 may also provide the lights, the buttons, the speaker, the microphone, or the other input devices that allow the user to provide caller treatment inputs (similar to the ATA 104).

One skilled in the art will recognize that the input devices on the ATA 104 and the client device 116 may take many different forms. Some input devices may interact with the user using lights or buttons. Other input devices may incorporate LCD displays, touch screens or pads, voice recognition, or other means of user information and control.

Referring now to FIG. 2, the VoIP provider system 132 is shown in more detail. In exemplary embodiments, the VoIP provider system 132 may comprise a caller vetting server 202, a voicemail server 204, an IVR server 206, and an announcement server 210. Alternative embodiments may comprise more, less, or functionally equivalent components.

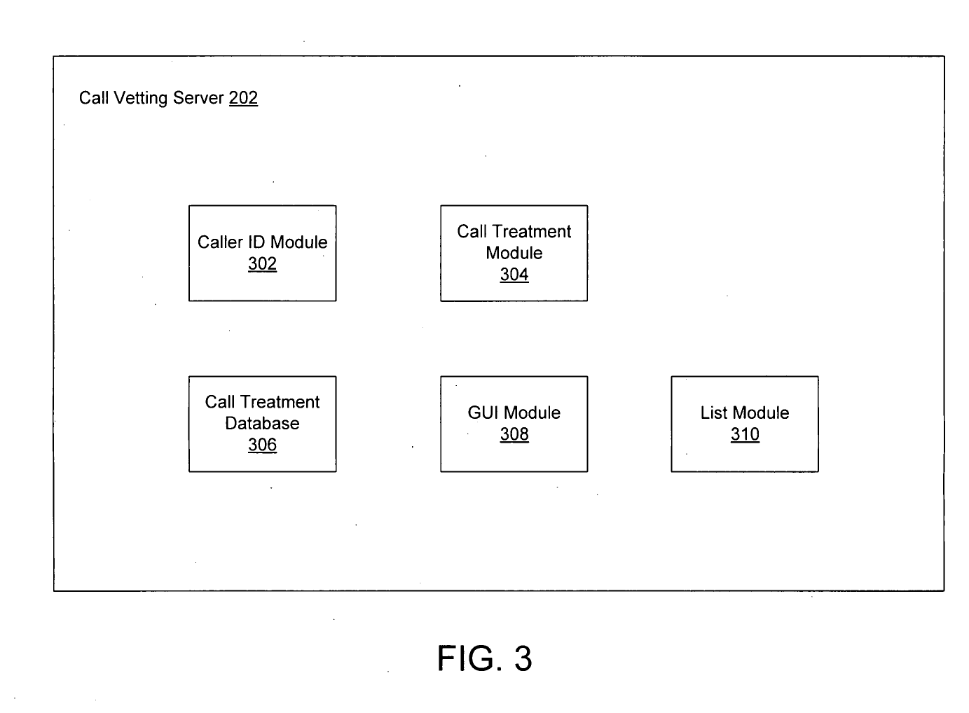

In embodiments of the present invention, an inbound call intended for the user may originate from the user's PSTN line, an ITSP providing origination services (both from other PSTN lines as well as from soft phone service providers), or from another subscriber to the same VoIP service. In each embodiment, the caller ID for the calling party may be blocked, unavailable, or unknown. These inbound calls may be routed to the call vetting server 202. In exemplary embodiments, the caller vetting server 202 is configured to look up a corresponding call treatment for the incoming call and apply the treatment. The corresponding call treatment may be based on a category of the incoming call. The category, in turn, may be based on a caller ID (or lack of caller ID) associated with the incoming call. The caller vetting server 202 will be discussed in more details in connection with FIG. 3.

The voicemail server 204 is configured to receive and store voicemails for a user. In some embodiments, an incoming call may be directly sent to the voicemail system (e.g., calls that are on a black list or from a caller the user has indicated that they do not wish to talk to). In other embodiments, the incoming call may be directed to the voicemail server 204 when the user is not available to answer the incoming call (e.g., after a predetermined number of rings).

One call treatment may comprise sending the call to the IVR server 206 in order to verify the identity and legitimacy of a caller. In one embodiment, an incoming call from an unknown or uncategorized phone number is redirected to the IVR server 206. The IVR server 206 may query the caller for information that can establish the legitimacy of the call. In the case of a call from a known phone number that has not been categorized, the IVR server 206 may instruct the caller to hang up and expect a call from the VoIP service provider 132. This case takes advantage of the fact that many telemarketers do not have the ability to receive in-bound calls. Similarly, the IVR server 206 may request that the unknown caller provide a password or personal identification number in order to allow the call to go through or to identify that the phone number is legitimate.

In some embodiments, the IVR server 206 may present a personal challenge to the caller based on personal recorded questions from the subscriber. In an embodiment where the caller only wants to receive calls from close friends or family members, the personal challenge may be customized to ask questions that only such callers would know the answer to. The personal challenge may be, for example, “What European country did I visit last summer?” or “What is my cat's name?” A limited vocabulary required to answer these personal challenges may lend itself to speaker independent voice recognition. Alternatively, a multiple choice response may be solicited where the caller may use a keypad, for example, to enter a correct answer. In yet other embodiments, multiple challenges may be provided with results scored to determine if a calling number should be added to the user's white list. This type of phone number verification may be used as a screen for all calls coming from phone numbers that have not yet been categorized into white or black lists.

The announcement server 208 is configured to provide a predetermined announcement to a caller sending the incoming call. For example, the announcement server 208 may inform the caller that the call from the caller's number will not be accepted because the caller ID is being blocked. Any type of announcement may be provided by the announcement server 208 based on a category associated with the incoming call.

Referring now to the FIG. 3, the caller vetting server 202 is shown in more detail. The caller vetting server 202 may comprise a caller ID module 302, call treatment module 304, a call treatment database 306, an optional graphical user interface (GUI) module 308, and a list module 310. It should be noted that alternative caller vetting server 202 may comprise less, more, or functionally equivalent modules. For example, some of the modules of the caller vetting server 202 may be embodied within the ATA 104 thus resulting in the ATA 104 performing some of the functions discussed below.

In some embodiments, the caller module 302 is configured to determine the caller ID associated with the incoming call. In alternative embodiments, the caller ID module 302 may receive the caller ID from the ATA 104 (e.g., when the incoming call is redirected by the ATA 104). As such, the caller module 302 may be optional in the caller vetting server 202.

In exemplary embodiments, the call treatment module 304 applies a predetermined call treatment to an incoming telephone call. Initially, the call treatment module 304 categorizes the incoming call based on the caller ID or lack of caller ID. Based on the category, the predetermined call treatment is determined and applied. A plurality of predetermined call treatment preferences may be stored in the caller treatment database 306 for the user.

The caller treatment database 306 may comprise any data structure configured to store data. The caller treatment database 306 may be stored within any storage media further described herein.

In exemplary embodiments, the GUI module 308 allows the user to exchange information for the VoIP provider system 132. For example, the GUI module 308 allows the user to review call logs and voicemails in addition to providing preference settings. For each call in the call log or voicemail, a flag, icon, or other distinguishing characteristic may be displayed to indicate what call treatment was applied.

In some embodiments, the user may choose to categorize or re-categorize the phone number associated with any particular call. For example, a message from a phone number that has not been previously placed on any white or black list may go into a folder marked as uncategorized. The user may, upon listening to the voicemail, place the originating phone number on a black list so that in the future calls from that phone number will get the desired treatment (e.g., simple termination of the call).

Other folders may also be provided by the GUI module 308. Messages from callers lacking caller ID information may be placed in a “junk mail” folder so that the user may choose to retrieve those messages knowing that the messages are from unknown callers. Messages from blacklisted phone numbers may similarly be placed into a special folder or otherwise identified. This gives the user the ability to listen to the message or change the treatment applied to calls from a particular phone number or otherwise modify the call flow for calls from that phone number.

The exemplary list module 310 compiles and maintains caller lists. These caller lists may comprise white lists (of desired phone numbers) and black lists (of undesired phone numbers). Some call treatments may typically be intended for calls associated with the white list. Such treatments might include letting the call ring through or forwarding the call to a user's cell phone number. Calls associated with the black list may receive a different call treatment (e.g., termination of the call or directing the call to the announcement server 208). The caller may be able to define default call treatments for these white list and black list phone numbers as well as customize call treatments on a phone number by phone number basis (e.g., using the GUI module 308).

In exemplary embodiments, the user is able to control the list of phone numbers and call treatments are to be applied and under what circumstances. In one embodiment, the user's list may be compiled by the list module 310 from address books which may reside on the user's computing device, cellular phone, or other sources.

The list may also be derived from community lists of phone numbers for which other members of the community have selected call treatments. For example, if a particular phone number is found to frequently appear on various user's black lists (e.g., who share the same VoIP service provider or are otherwise affiliated and share information), then the user may opt to have such a phone number automatically added to his own black list by the list module 310. As a result, the user benefits from the judgments made by the community of users as a whole. For any particular call where the caller ID is known, the user may select a button, perform a gesture, give a voice command, or provide other user input (e.g., activate a button on a graphical user interface) to indicate that the caller ID should be added to the user's white list or black list.

For calls where the caller ID is available, several call treatments may be applied singly or in combination based on the user's preferences and settings. These call treatments may comprise ringing the user's phone, forwarding the call to another number or soft phone address (e.g., user's cellular phone number) or group of numbers/addresses for sequential ringing, sending the call through to the destination ATA, simultaneously ringing multiple designated phone numbers, forwarding the call to a designate phone number, sending an instant message or e-mail to the user, or ringing indefinitely until the caller terminates the call. In some embodiments, the call may be terminated with a busy signal generated by the VoIP provider system 132 or by the destination ATA. In another embodiment, the call may be sent to the voicemail server 204 where the caller will be asked to leave a voicemail. Alternatively, the call may be terminated by playing a SIT generated by the VoIP provider system 132 or the destination ATA to indicate to any telemarketing computer placing the call that the number is out of service. The call treatment may further comprise sending the call to the IVR server 206 or the announcement server 208. The announcement server 208 may inform the caller that the call from the caller's number will not be accepted or any other appropriate message. It should be noted that in alternative embodiments, the functions of the caller vetting server 202 may be performed by the destination ATA.

For calls where the caller ID is not available, several call treatments are also applicable. These call treatments may comprise terminating the call, applying a busy signal, applying a SIT or fax/modem negotiation tone, sending the call to the voicemail server 204, and allowing the call to ring indefinitely until the caller terminates the call. The call may also be forwarded to the announcement server 208. In one embodiment, the announcement server 208 may instruct the caller to dial again using *82 to unblock the callers phone number. In other embodiment, the call may be directed to the IRV server 206.

Any of these rules for call treatment for when the caller ID is available or not available may be conditioned on the caller ID (or lack thereof) or address of the calling party as well as other factors. These factors may include time of day, time of year, proximity to an election, calling patterns, or telemetry gathered from the destination ATA (including missing telemetry which may arise from loss of power or broadband connectivity to the ATA), for example. Other telemetry which may factor into the call treatments comprise whether the user has pressed a “do not disturb” button on the ATA 104, whether an ATA 104 equipped to communicate with a user's cell phone has detected the presence of the user's cell phone in the home environment, whether a particular member of the household is presently in the home environment (e.g., determined by the member entering a PIN when in the home environment).

In the embodiment where the call vetting server 202 or ATA 104 applies the SIT directly to a SIP connected call causing the call to go “off hook,” a telemarketer computer cannot apply heuristics to determine that the SIT is not legitimate by listening for an off-hook event. The detection of an off-hook event is a typical strategy employed by telemarketers to avoid being spoofed by the SIT.

For calls originating from soft phone services such as Skype or GoogleTalk, caller ID may be less relevant since the caller may not be associated with a phone number. However, it may be possible for the VoIP service provider 132 to determine where the call originated from based on its originating IP address or other indications. Special rules such as those described above may be applied to these types of calls based on user preferences.

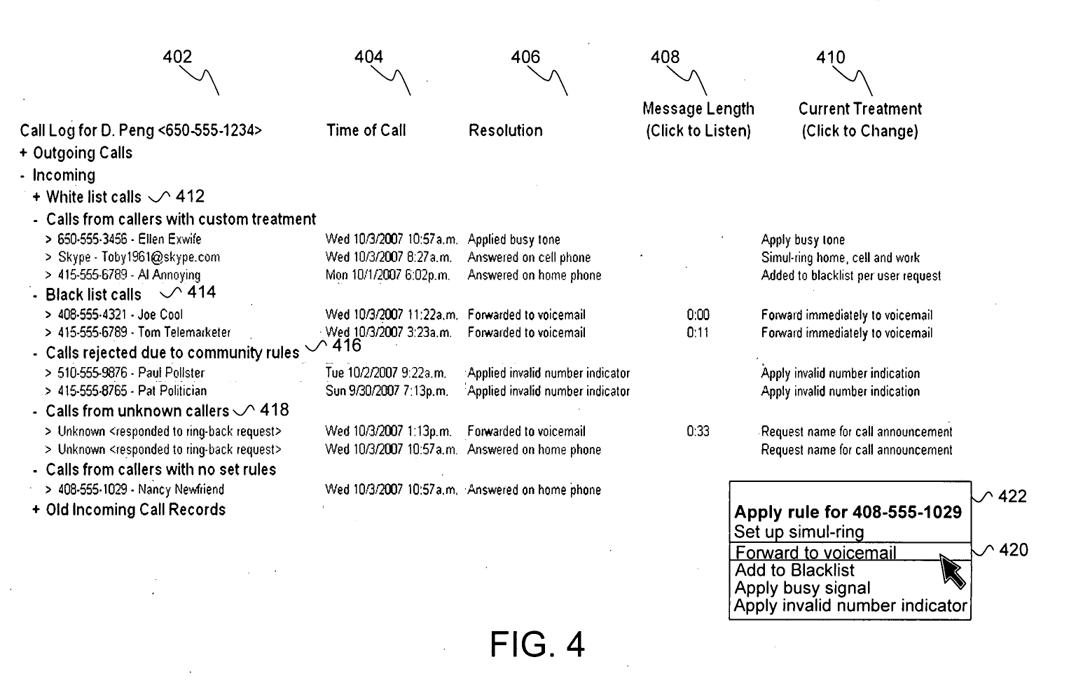

Referring now to FIG. 4, an exemplary graphical user interface 400 associated with a call log 402 is shown. The graphical user interface 400 may indicate for each call of the call log 402, a time of the call 404, resolution of the call 406 (e.g., what call treatment each call received), a message length 408, and a current treatment setting 410.

Various categories are established for the user. These categories comprise a white list 412, a black list 414, community rules rejected calls 416, unknown 418, and no rule calls 420. The user may establish any number of categories and category types. It should be noted that a category may comprise one or more caller IDs.

The graphical user interface 400 allows the user to change rules for one or more incoming calls. As shown, the user has selected a caller ID (i.e., “408-555-1029”) to change. In the present example, the user is revising the call treatment to directly forward any future incoming calls from this caller ID to voicemail by selecting the voicemail selection 420 in revision box 422. While a revision box 422 with a set of call treatments is provided, it should be noted that any means for allowing the user to change or set up new call treatments may be used. For example, the user may manually enter a call treatment in a blank field of the graphical user interface 400.

The graphical user interface 400 also allows the user to enter or upload caller IDs to the VoIP provider system 132. For example, one or more fields may be provided for the user to enter the caller ID and associated call treatment(s). The user may also use input devices on the ATA 104 to indicate caller IDs that should be added to various lists (e.g., white list, black list) or categories.

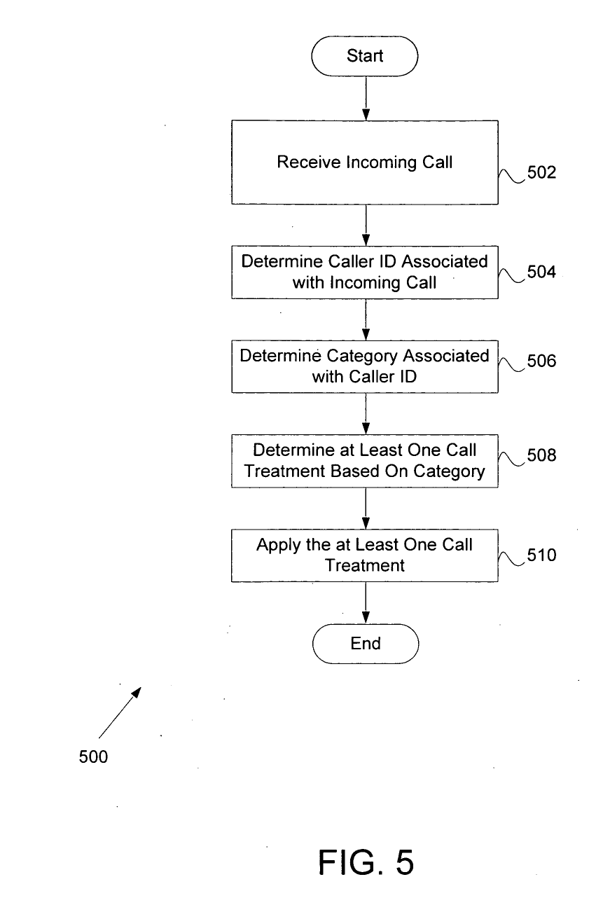

Referring now to FIG. 5, a flowchart of any exemplary method for providing privacy in a VoIP system is shown. In step 502, an incoming call is received. In exemplary embodiments, the incoming call may be received by the ATA 104 and redirected to the VoIP provider system 132. In other embodiments, the incoming call may automatically be routed to the VoIP provider system 132.

A caller ID is determined for the incoming call in step 504. In some embodiments, the ATA 104 may determine the caller ID and provide it to the caller ID module 302. In other embodiments, the caller ID module 302 may determine the caller ID.

In step 506, a category associated with the caller ID is determined. In embodiments where the caller ID is available, the call treatment module 304 may access a call treatment database 306 and look up the caller ID to determine the category of the incoming call. In embodiments where a caller ID is blocked or not available, the call treatment module 304 may assign the incoming call to a black list or a category specifically set up for non-caller ID calls.

In step 508, at least one call treatment is determined for the incoming call. The call treatment is associated with the category the incoming call is determined to be associated with. Any number of call treatments may be applied to the incoming call.

The one or more call treatments are then applied in step 510. In some embodiments, the implementation of the call treatment comprises the call treatment module 304 sending instructions to other modules or servers of the VoIP provider system 132. In other embodiments, the call treatment module 304 forwards the incoming call to other modules or servers of the VoIP provider system 132. In yet other embodiments, the call treatment module 304 performs the one or more call treatments.

In embodiments where the ATA 104 performs some or all of the functions of the call vetting server 202, the ATA 104 may comprise means to download or query white lists, black lists, call treatments, and other information stored in the VoIP provider system 132. Based on this information, the ATA 104 may determine how the incoming call may be handled. The ATA may further comprise means for tone generation such that all or a portion of a special information tone or fax/modem tone may be played to spoof automatic dialers into removing the user's phone number from their call lists. The ATA 104 may also comprise means to take other actions selectively based on user preferences stored locally or centrally at the VoIP provider system 132.

The above-described modules can be comprises of instructions that are stored on storage media. The storage media may comprise computer readable media or machine readable media including, but not limited to a hard drive, CD, DVD, RAM, ROM, or any other storage media. The instructions can be retrieved and executed by a processor. Some examples of instructions include software, program code, and firmware. Some examples of storage media comprise memory devices and integrated circuits. The instructions are operational when executed by the processor 202 to direct the processor to operate in accordance with embodiments of the present invention. Those skilled in the art are familiar with instructions, processor(s), and storage media.

The present invention is described above with reference to exemplary embodiments. It will be apparent to those skilled in the art that various modifications may be made and other embodiments can be used without departing from the broader scope of the present invention. For example, embodiments of the present invention may be applied to any system (e.g., non speech enhancement system) as long as a noise power spectrum estimate is available. Therefore, these and other variations upon the exemplary embodiments are intended to be covered by the present invention

1. A method for providing privacy in a VoIP system, comprising:
receiving an incoming call;
identifying a category associated with the incoming call;
accessing a call treatment database to determine at least one call treatment associated with the category; and
applying the at least one call treatment to the incoming call.

2. The method of claim 1 wherein identifying the category comprises determining a caller identifier associated with the incoming call.

3. The method of claim 1 wherein identifying the category comprises determining that the incoming call has a blocked caller identifier.

4. The method of claim 1 further comprising providing a graphical user interface to a user, the graphical user interface configured to allow the user to access at least a call log.

5. The method of claim 4 further comprising receiving a command to recategorize a caller identify via the graphical user interface.

6. The method of claim 4 further comprising receiving user preferences for call treatments via the graphical user interface.

7. The method of claim 1 further comprising maintaining a white list of caller identifiers.

8. The method of claim 1 further comprising maintaining a black list of caller identifiers.

9. The method of claim 8 wherein maintaining the black list of caller identifiers comprises adding caller identifiers from a community list to the black list.

10. The method of claim 8 wherein maintaining the black list of caller identifiers comprises adding a caller identifier to the black list in response to an input from a graphical user interface.

11. The method of claim 1 wherein applying the at least one call treatment comprises sending the incoming call to a voicemail server.

12. The method of claim 1 wherein applying the at least one call treatment comprises sending an announcement to a caller.

13. The method of claim 1 wherein applying the at least one call treatment comprises verifying a caller.

14. The method of claim 13 wherein verifying the caller comprises providing at least one personal challenge to the caller.

15. The method of claim 13 wherein verifying the caller comprises requesting a password from the caller.

16. The method of claim 1 wherein receiving the incoming call comprises receiving the incoming call via a redirect from a gateway associated with a call recipient.

17. A system for providing privacy in a VoIP system, comprising:
a call treatment database configured to store predetermined call treatments associated with one or more categories of incoming calls; and
a call treatment module configured to receive an incoming call, categorize the incoming call based on a caller ID associated with the incoming call, and determine and apply a call treatment from the call treatment database associated with the category.

18. The system of claim 17 further comprising a voicemail server configured to receive the incoming call routed by the call treatment module and to store a voicemail for the incoming call routed by the call treatment module.

19. The system of claim 17 further comprising an announcement server configured to send an announcement to the incoming call based on instructions received from the call treatment module.

20. The system of claim 17 further comprising an interactive voice recognition system configured to verify a caller associated with the incoming call.

21. The system of claim 17 further comprising a graphical user interface module configured to provide a graphical user interface to a user, the graphical user interface configured to provide call logs and receive call treatment preferences from the user.

22. A machine readable medium having embodied thereon a program, the program providing instructions for a method for providing privacy in a VoIP system, the method comprising:
receiving an incoming call;
identifying a category associated with the incoming call;
accessing a call treatment database to determine at least one call treatment associated with the category; and
applying the at least one call treatment to the incoming call.
